(19) United States
(12) Patent Application Publication
(10) Pub. No.: US 2015/0141227 A1
(43) Pub. Date: May 21, 2015

(54) Machine to Assemble Cardboard Boxes While Maintaining Them Square

(71) Applicants: Elio Oscar Nemi, Buenos Aires (AR); Javier Finelli, Buenos Aires (AR)

(72) Inventors: Elio Oscar Nemi, Buenos Aires (AR); Javier Finelli, Buenos Aires (AR)

(21) Appl. No.: 14/520,503

(22) Filed: Oct. 22, 2014

(30) Foreign Application Priority Data
Nov. 21, 2013 (AR) 20130104309

(51) Int. Cl. B31B 13/00

(52) U.S. Cl. CPC B31B 13/00
USPC 493/84

(57) ABSTRACT

A machine to assemble cardboard boxes by stages while ensuring they remain in square, comprising at least three box folding and assembly stations; a conveyor belt; multiple pairs of buckets, each pair being mounted on a fastening chock which is carried by the conveyor belt; a support flap affixed to each chock on the vertex corresponding to the flat side of the support flap; a storage cart for pre-shaped, folded boxes, hereinafter referred to as pre-shapes, mounted on a couple of conveyor belts; Four suction pads mounted on a transport mechanism; a belt mounted on the storage cart; a plate to close the front bottom lid of the box; a plate to close the back lid; a device to apply glue to both lids; and a pressure plate.

### RELATED APPLICATIONS

This application claims the benefit of Argentina Patent Application No. 2013 0104309 filed on Nov. 21, 2013. The entire disclosure of this application is incorporated herein by reference.

### FIELD OF THE INVENTION

This invention generally relates to machines and methods used in the packaging industry. More specifically, the invention relates to an arrangement or machine and to the methods to assemble cardboard boxes that are carried on a conveyor belt The invention is particularly pertinent for folding the boxes while maintaining them in vertical position and in square during the assembly process.

### BACKGROUND OF THE INVENTION

The state of the art shows different arrangements and methods for folding the various parts of a box (made of cardboard or any other similar material) that is carried by a conveyor belt These arrangements include folding devices and rotary folders. These arrangements and methods generally have several limitations that become apparent when the previous state-of-the-art tries to fold the bottom of six sided boxes. Six sided boxes tend to lose their rectangular shape and revert to their original flat shape after being erected on a conveying means.

When the box moves horizontally along a stationary folding device designed to laterally fold the box, it is the side component of this force that folds the flap. However, the longitudinal component of the resulting force pushes the flap backwards against the longitudinal flow of the boxes, thus bringing them out of square. Larger flaps cause the stationary folding devices to induce larger longitudinal forces, thus tending to bring the boxes out of square when the flap is folded.

This invention specifically resolves the problem by means of a pre-shaped box that is folded flat using a machine that follows several steps.

### SUMMARY OF THE INVENTION

The invention consists of an assembly process for boxes made out of cardboard or similar material, where a system consisting of chain- or timing belt-driven carts maintain the box in a vertical position, guided by at least three of its sides. The carts move, carried by the conveyor belt, with a vertical support flap, so that they may travel the whole distance and appear at the other end. The invention also comprises a storage cart for pre-shaped folded boxes (hereinafter referred to as pre-shapes or blanks), which are vertically mounted on a storage cart In the first step the pre-shapes are fed into a first station, where the box is shaped and a first bottom lid and a second bottom lid are folded. The cardboard boxes, especially those using multi-layer corrugated cardboard, tend to deform or revert to their original flat position once the box has been shaped. In the next step, the box is transferred to a second station, where a jet of glue is applied to the folded bottom lids, and then it is transferred to a third station where the third and fourth bottom lids are folded onto the glue. A pressure plate goes down inside the box and exerts pressure on the bottom lids to contribute to the gluing. Once the pressure plate is raised, the box is conveyed to a third station, where the first and second top lids are folded. It is then moved to a fourth station where folding of the third top lid takes place. The box folding process is completed in a fifth station where the fourth top lid is folded, with the box then being conveyed to other operations.

### BRIEF DESCRIPTION OF ILLUSTRATIONS

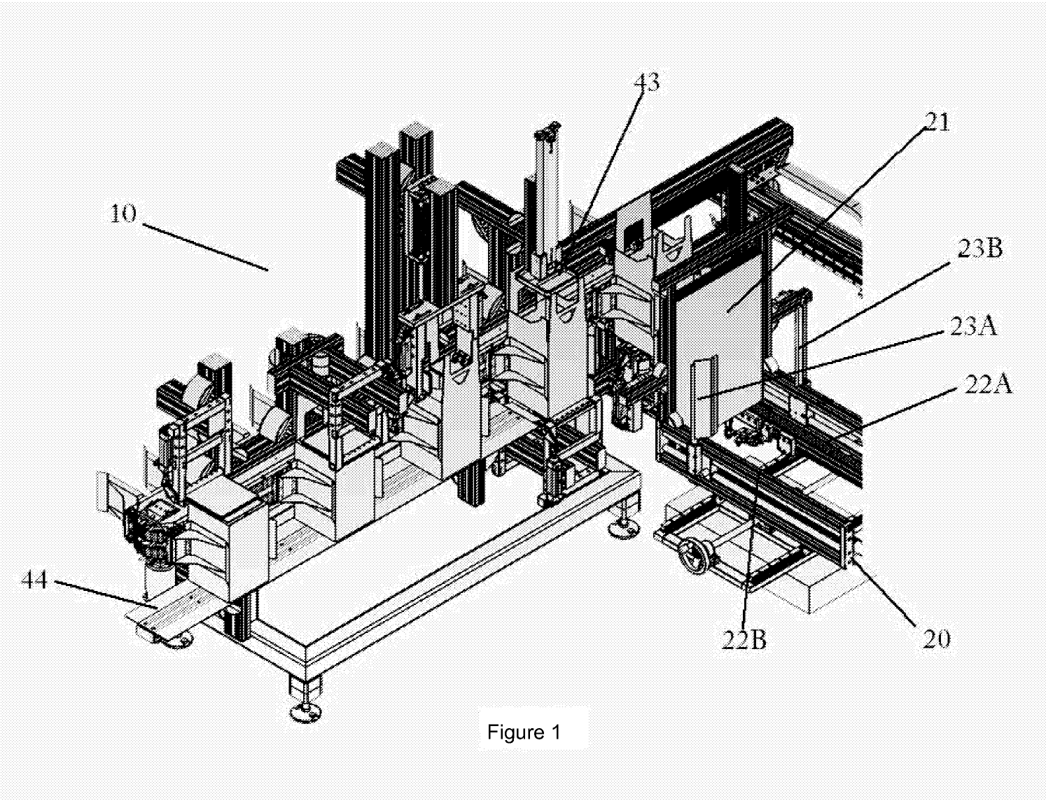

FIG. 1 shows an isometric view of the machine, including the storage cart.

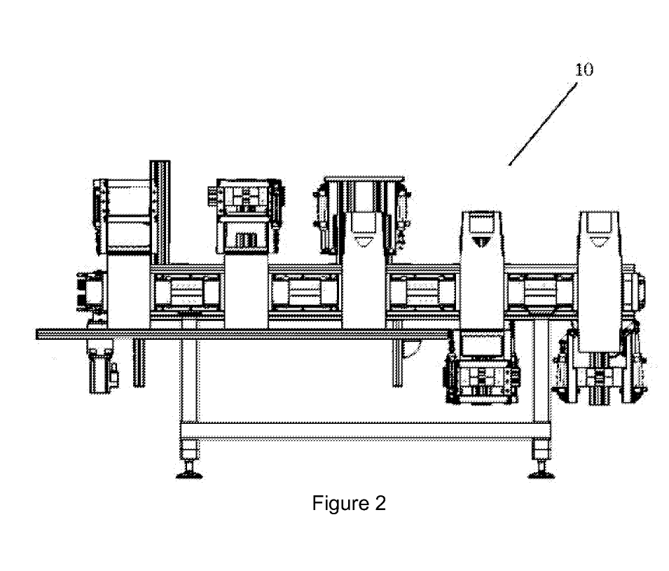

FIG. 2 shows the box folding and assembly stages.

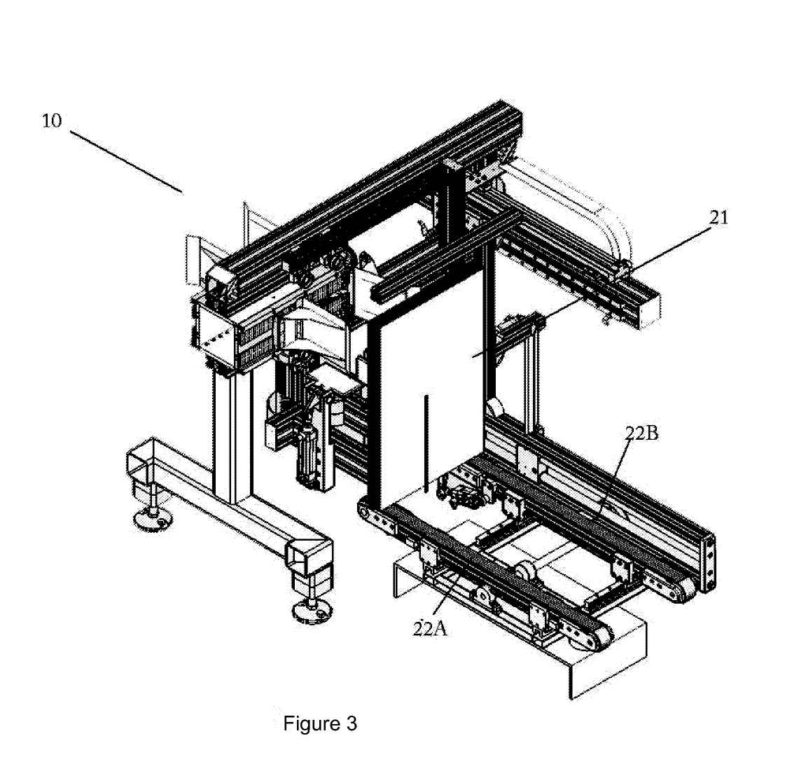

FIG. 3 shows an isometric view of the first box folding and assembly station, with the storage cart.

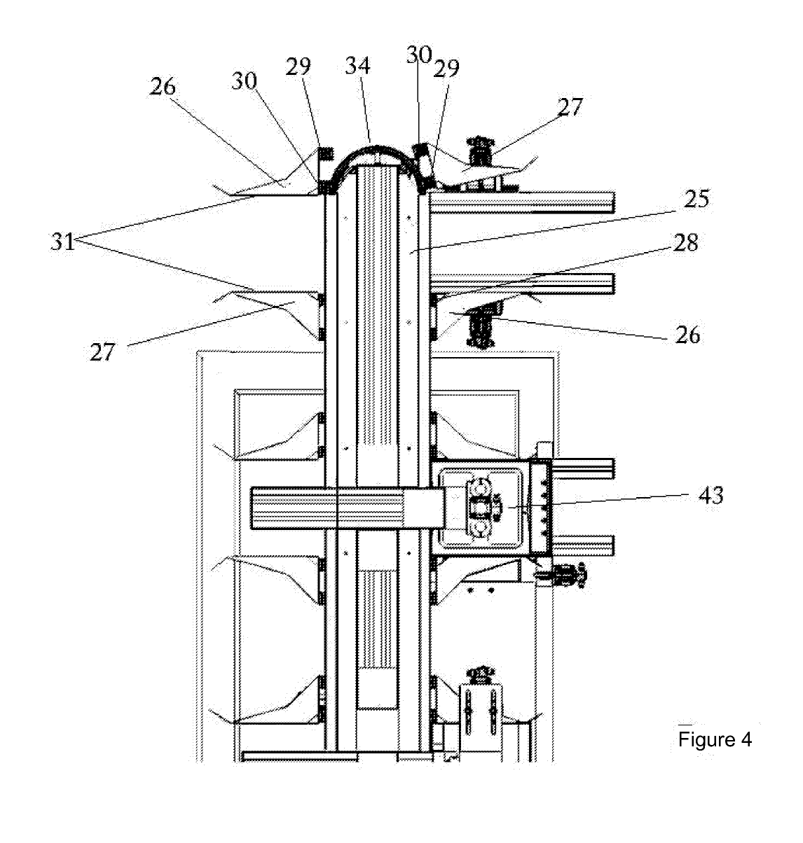

FIG. 4 shows a top view of the containment, flap conveyor cart.

FIG, 5 illustrates the first stage, with a box that starts to be folded and assembled.

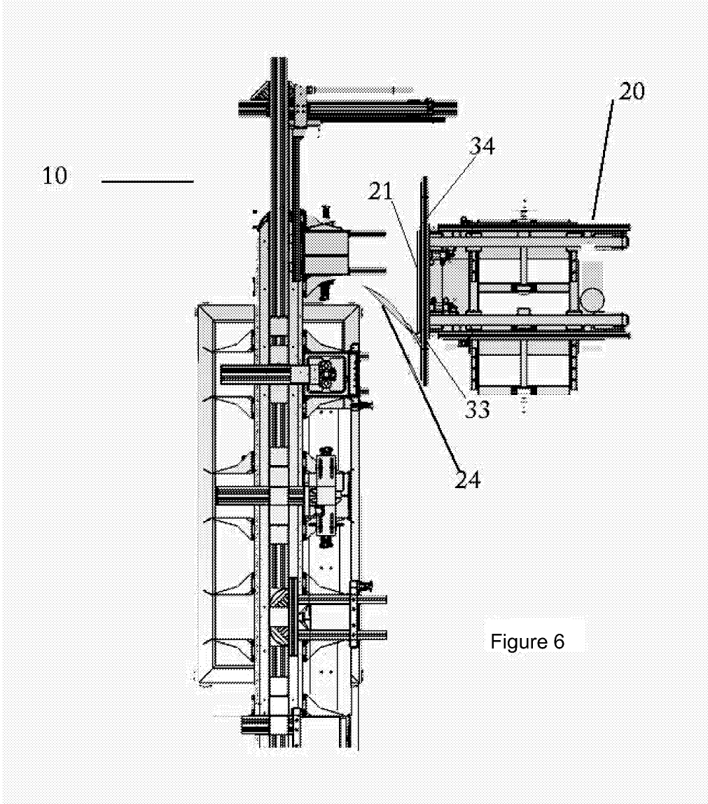

FIG. 6 shows a top view of the first and second box folding and assembly station.

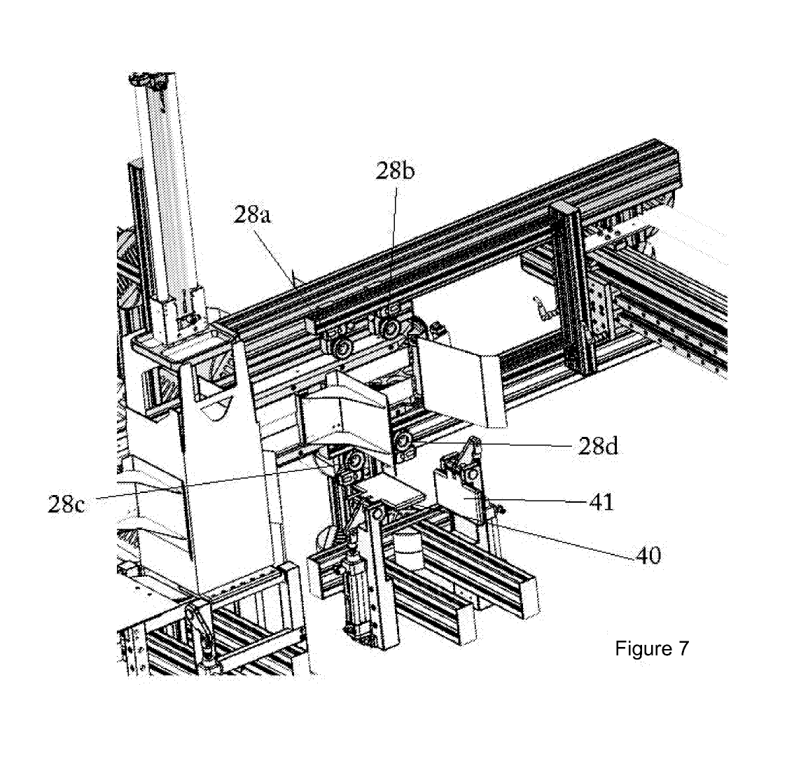

FIG. 7 shows a detailed isometric view of the first box folding and assembly station.

### DESCRIPTION OF THE INVENTION

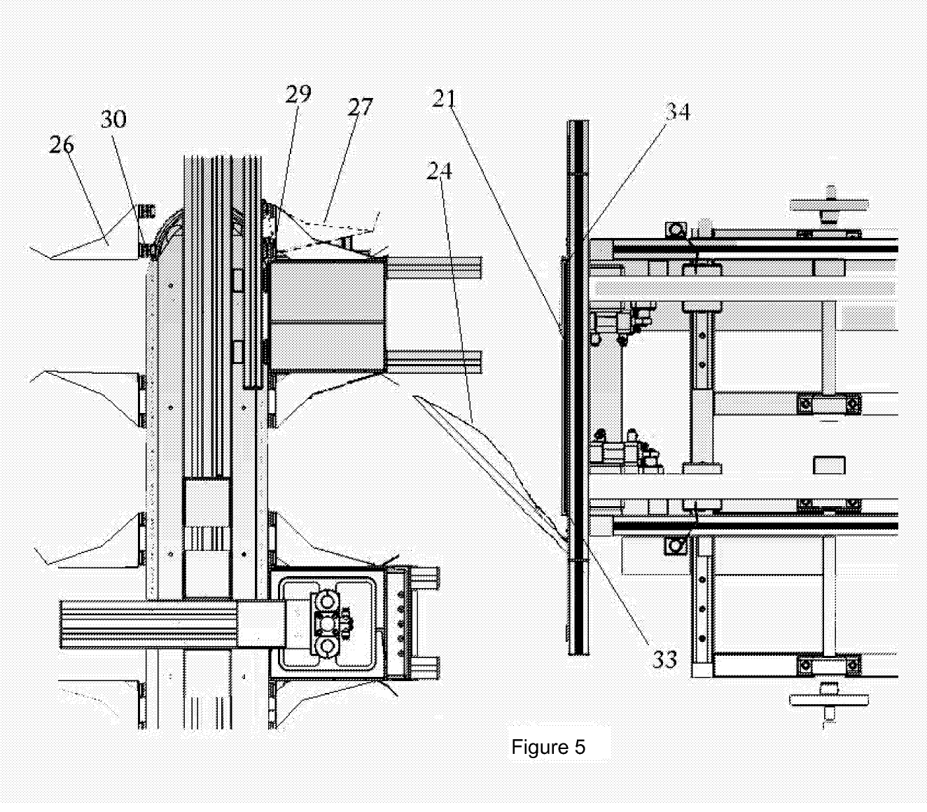

FIG. 1 shows an arrangement 10 for box folding comprising five stations. As shown in FIG. 1, a storage cart 20 stores the pre-shapes 21. As shown in FIG. 3, pair of conveyor belts 22a and 22b moves the pre-shapes cart 21 towards the first station. Pair of vertical flaps 23a and 23b, shown in FIG. 1, are located at each side of the storage cart to keep the pre-shape in vertical position. As shown in FIGS. 5 and 6, a curved bar 24 is mounted on the storage cart 20, in correspondence with the front guiding section 33 of the pre-shapes.

Referring now to FIG. 4 is shown a top view of the machine subject matter of this invention, showing the first and second box folding and assembly stations. A conveyor belt 25 revolves like a carrousel, passing in front of the box folding and assembly stations and carrying multiple support flaps (front flap 26 and rear flap 27), with the flat sections of the flaps facing each other. Each flap is mounted on the conveyor belt 25 through a fastening chock 28. Each flap is mounted on the conveyor belt 25 through a fastening chock 28. The support flaps are affixed to fastening chocks 28. These are in turn affixed to the conveyor belts at the ends 29 and of the chocks. When in operation, the conveyor belt 25 moves clockwise and, as it reaches the end 34, the support flaps pivot around the fastening point 29 and 30 to the chock linking each support flap to the conveyor belt 25, as shown in FIG. 4. Therefore, as the support flaps go past the end 34 of the conveyor belt 25, the front support flap 26 does not rotate, and it remains perpendicular to the belt 25, with its face 31 at a 90° angle with the belt 25, whereas the back support flap 27, does rotate, moving it to an angle larger than 90° vis-à-vis the conveyor belt 25.

FIG. 7 shows the first box folding and assembly station. Four suction pads 24a, 24b, 24c and 24d are mounted to a conveying mechanism to move towards the pre-shapes storage cart, passing between the sides 31 of the support flaps until reaching the front side of the storage cart. The pads suction the pre-shapes and retract towards the conveyor belt 25. The pre-shape 21 that is parallel to the conveyor belt 25 has a front side 33 and a backside 34. The pre-shape 21 moves towards and is guided to the conveyor belt 25. The curved bar 24 guides the pre-shape 21, and the rear end 34 of the pre-shape 21 moves forward more than the back side 33, until coming into contact with the face 31 of the back support flap 27. The force exercised upon it causes the pre-shape to open until actually forming the box. This allows easily bringing the box into the first station, where it is assembled and brought square. As the conveyor belt 25 makes a full turn, the back support flap 31 again forms a 90° angle with the belt 25 and the pressure exerted by the faces 30 and 31 of the front and back support flaps maintains the box in shape and in square, counteracting the stress exercised by the cardboard, which tends to recover its flat position. Next, closing plate closes the front bottom lifted off the box, and then another back lid closing plate 41 closes the back bottom lip. Glue is then applied to the outer part of the front and back bottom lids, and the conveyor belt 25 moves to the second station where the side bottom lids are folded onto the front and back lid of the box. Once all four bottom lids have been folded, a pressure plate 43 moves down inside the shaped box and it presses the bottom against the floor 44 so that the bottom of the box is properly glued. The assembled, in-square box moves to the next station, where top lids are folded and other operations are also carried out.

1. A machine to assemble cardboard boxes by stages while ensuring they remain in square, characterized in comprising:
at least three box folding and assembly stations;
a conveyor belt;
multiple pairs of buckets, each pair being mounted on a fastening chock which is carried by the conveyor belt;
a support flap affixed to each chock on the vertex corresponding to the flat side of the support flap;
a storage cart for pre-shaped, folded boxes, hereinafter referred to as pre-shapes, mounted on a couple of conveyor belts;
a bar mounted on the storage cart;
four suction pads mounted on a transport mechanism;
a plate to close the front bottom lid of the box;
a device to apply glue to both lids; and
a pressure plate.

2. The machine in claim 1, characterized in that a bar is placed in the storage cart to face the front of the pre-shape.

3. The machine in claim 2, characterized in that said pads suction a pre-shape removing it from the storage cart towards the first box folding and assembly station, while the bar guides the pre-shape so that its rear end is pushed against the back support flap to counteract the stress exercised by the cardboard, which tends to regain its flat position.
